(19) United States
(12) Patent Application Publication
(10) Pub. No.: US 2017/0262119 A1
(43) Pub. Date: Sep. 14, 2017

(54) TOUCH CONTROL DEVICE DRIVE METHOD, TOUCH CONTROL DEVICE DRIVE CIRCUIT AND TOUCH CONTROL DEVICE

(71) Applicant: Wuhan China Star Optoelectronics Technology Co., Ltd., Wuhan (CN)

(72) Inventors: Chunpeng GUO, Shenzhen (CN); Yingqi WANG, Shenzhen (CN); Chun-hung HUANG, Shenzhen (CN)

(73) Assignee: Wuhan China Star Optoelectronics Technology Co., Ltd., Wuhan (CN)

(21) Appl. No.: 15/275,456

(22) Filed: Sep. 25, 2016

(30) Foreign Application Priority Data
Mar. 11, 2016 (CN) 201610139895.6

(51) Int. Cl. G06F 3/041

(52) U.S. Cl. CPC G06F 3/0416

(57) ABSTRACT

Provided are a touch control device drive method, a touch control device drive circuit and a touch control device. The method comprises: providing a plurality of touch control drive signals for detecting a position where a touch point of the touch control device is; providing a plurality of periodic scan signals, and in one period, the scan signal comprises a first high voltage level signal, of which a duration is a first preset time, and the first high voltage level signals of the two adjacent scan signals are spaced with a first time interval; providing a plurality of switch signals, wherein each switch signal comprises a first, a second and a third switch sub signals, and the first, the second and the third switch sub signals are respectively employed to control on or off of a first, a second and a third thin film transistors in one pixel.

### FIELD OF THE INVENTION

The present invention relates to a touch control field, and more particularly relates to a touch control device drive method, a touch control device drive circuit and a touch control device.

### BACKGROUND OF THE INVENTION

In the recent years, with the high performance and variety developments of the touch control devices, such as the touch control screen mobile phone, the touch control navigation system, the devices in which the touch control function is integrated in the liquid crystal display device has gradually decreased. The In cell touch control device has become the focus of the research due to the thinner thickness. The display and touch control of the In cell touch control device alternately perform in different time. The work process of the touch control panel includes the display portion and the touch control portion. For the display portion, one Source line corresponds to one Pixel. the thin film transistors corresponded with the red sub pixel, the green sub pixel and the blue sub pixel in one pixel are periodically activated with three MUX (multiplexer), which sequentially are the MUXR signal, the MUXG signal, the MUXB signal, the MUXR signal, the MUXG signal and the MUXB signal to make the Source line charge the corresponding sub pixel electrode. In one period, the MUXR signal, the MUXG signal, the MUXB signal sequentially controls the thin film transistors corresponded with the sub pixels of the corresponding colors to be activated. For the touch control portion, the touch control drive signal constantly scans. The touch control drive signal is a direct current signal in the display stage, and is an alternating current signal in the touch control stage. If there is no touch control operation, the touch control drive signal has no change. If there is a touch control operation happening, the position where the touch control point is determined with the change position of the touch control drive signal. Meanwhile, a plurality of scan signals also exists in the touch control panel. With the coupling effect, the high low voltage level switch moments of the scan signal or the MUXR signal, the MUXG signal, the MUXB signal will make the touch control drive signal which previously is a direct current signal appear more glitches, and thus influence the touch control drive effect.

### SUMMARY OF THE INVENTION

The present invention provides a touch control device drive method, applied in a touch control device, wherein the touch control device drive method comprises:

providing a plurality of touch control drive signals, wherein the plurality of touch control drive signals are employed for detecting a position where a touch point of the touch control device is;

providing a plurality of scan signals, wherein each scan signal is loaded on a gate of a thin film transistor on an array substrate in the touch control device, and the scan signal is a periodic signal, and in one period, the scan signal comprises a first high voltage level signal, of which a duration is a first preset time, and the first high voltage level signals of the two adjacent scan signals are spaced with a first time interval, wherein the first time interval is larger than the first preset time; and

providing a plurality of switch signals, wherein each switch signal comprises a first switch sub signal, a second switch sub signal and a third switch sub signal, and the first switch sub signal, the second switch sub signal and the third switch sub signal are respectively employed to control on or off of a first thin film transistor corresponded with a first color sub pixel, a second thin film transistor corresponded with a second color sub pixel and a third thin film transistor corresponded with a third color sub pixel in one pixel, and the first switch sub signal, the second switch sub signal and the third switch sub signal cooperate with one another to be activate the first thin film transistor, the second thin film transistor and the third thin film transistor, and in one period, the first switch sub signal, the second switch sub signal, the third switch sub signal, the third switch sub signal, the second switch sub signal and the first switch sub signal sequentially control the corresponding thin film transistors to be activated, and different two switch sub signals which are adjacent are spaced with a second time interval, and no interval is between the same switch sub signals which are adjacent, and in the same point of the same period, no more than one switch sub signal controls the corresponding thin film transistor to be activated.

In two adjacent periods, no interval is between the same switch sub signals which are adjacent.

The touch control device drive method further comprises:

providing a plurality of charging signals, wherein each charging signal comprises a first charging sub signal, a second charging sub signal and a third charging sub signal, and the first charging sub signal, the second charging sub signal and the third charging sub signal are respectively employed to charge a first sub pixel electrode coupled to the first thin film transistor in the first color sub pixel, a second sub pixel electrode coupled to the second thin film transistor in the second color sub pixel and a third sub pixel electrode coupled to the third thin film transistor in the third color sub pixel in one pixel, and the first charging sub signal, the second charging sub signal and the third charging sub signal cooperate with one another to periodically charge the first sub pixel electrode, the second sub pixel electrode and the third sub pixel electrode, and in one period, as first switch sub signal is applied on the first thin film transistor, the first charging sub signal charges the first sub pixel, and as the second switch sub signal is applied on the second thin film transistor, the second charging sub signal charges the second sub pixel, and as the third switch sub signal is applied on the third thin film transistor, the third charging sub signal charges the third sub pixel.

In one period, the scan signal further comprises a first low voltage level signal, of which a duration is a second preset time, and the first high voltage level signal is 7V, and the first low voltage level signal is −5V.

The present invention further provides a touch control drive circuit, applied in a touch control device, wherein the touch control drive circuit comprises:

a touch control drive signal generation circuit, employed for generating a plurality of touch control drive signals, wherein the plurality of touch control drive signals are employed for detecting a position where a touch point of the touch control device is;

a scan signal generation circuit, employed for generating a plurality of scan signals, wherein each scan signal is loaded on a gate of a thin film transistor on an array substrate in the touch control device, and the scan signal is a periodic signal, and in one period, the scan signal comprises a first high voltage level signal, of which a duration is a first preset time, and the first high voltage level signals of the two adjacent scan signals are spaced with a first time interval, wherein the first time interval is larger than the first preset time; and

a switch signal generation circuit, employed for generating a plurality of switch signals, wherein each switch signal comprises a first switch sub signal, a second switch sub signal and a third switch sub signal, and the first switch sub signal, the second switch sub signal and the third switch sub signal are respectively employed to control on or off of a first thin film transistor corresponded with a first color sub pixel, a second thin film transistor corresponded with a second color sub pixel and a third thin film transistor corresponded with a third color sub pixel in one pixel, and the first switch sub signal, the second switch sub signal and the third switch sub signal cooperate with one another to be activate the first thin film transistor, the second thin film transistor and the third thin film transistor, and in one period, the first switch sub signal, the second switch sub signal, the third switch sub signal, the third switch sub signal, the second switch sub signal and the first switch sub signal sequentially control the corresponding thin film transistors to be activated, and different two switch sub signals which are adjacent are spaced with a second time interval, and no interval is between the same switch sub signals which are adjacent, and in the same point of the same period, no more than one switch sub signal controls the corresponding thin film transistor to be activated.

In two adjacent periods, no interval is between the same switch sub signals which are adjacent.

The touch control device drive device further comprises:

a charging signal generation circuit, employed for generating a plurality of charging signals, wherein each charging signal comprises a first charging sub signal, a second charging sub signal and a third charging sub signal, and the first charging sub signal, the second charging sub signal and the third charging sub signal are respectively employed to charge a first sub pixel electrode coupled to the first thin film transistor in the first color sub pixel, a second sub pixel electrode coupled to the second thin film transistor in the second color sub pixel and a third sub pixel electrode coupled to the third thin film transistor in the third color sub pixel in one pixel, and the first charging sub signal, the second charging sub signal and the third charging sub signal cooperate with one another to periodically charge the first sub pixel electrode, the second sub pixel electrode and the third sub pixel electrode, and in one period, as first switch sub signal is applied on the first thin film transistor, the first charging sub signal charges the first sub pixel, and as the second switch sub signal is applied on the second thin film transistor, the second charging sub signal charges the second sub pixel, and as the third switch sub signal is applied on the third thin film transistor, the third charging sub signal charges the third sub pixel.

In one period, the scan signal further comprises a first low voltage level signal, of which a duration is a second preset time, and the first high voltage level signal is 7V, and the first low voltage level signal is −5V.

The first color sub pixel is a red sub pixel, and the second color sub pixel is a green sub pixel, and the third color sub pixel is a blue sub pixel.

The present invention further provides a touch control device. The touch control device comprises the touch control drive circuit in any one embodiment as aforementioned.

In comparison with prior art, in one period, the first switch sub signal, the second switch sub signal, the third switch sub signal, the third switch sub signal, the second switch sub signal and the first switch sub signal sequentially control the corresponding thin film transistors to be activated, and no interval is between the same switch sub signals which are adjacent. Namely, the same switch sub signals which are adjacent are not required to switch, and thus the number of sequential high low voltage level switches can be decreased. Thus, the one interference to the touch control drive signal can be decreased so that the in the period, the number of the glitches in the touch control signals is decreased by one, and then the effect of the touch control drive is promoted.

Furthermore, in two adjacent periods, no interval is between the same switch sub signals which are adjacent. Thus, in the two adjacent periods, no interval is between the adjacent switch sub signals. Thus, the switch number of the high low voltage levels as switching from one period to the next period can be decreased. Therefore, the one interference to the touch control drive signal can be decreased so that the in the period, the number of the glitches in the touch control signals is decreased by one, again, and then the effect of the touch control drive is promoted in advance.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a sequence diagram of respective signals in the touch control device drive method according to one preferred embodiment of the present invention.

FIG. 2 is a circuit block diagram of the touch control device drive circuit according to one preferred embodiment of the present invention.

FIG. 3 is a structure diagram of the touch control device according to one preferred embodiment of the present invention.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

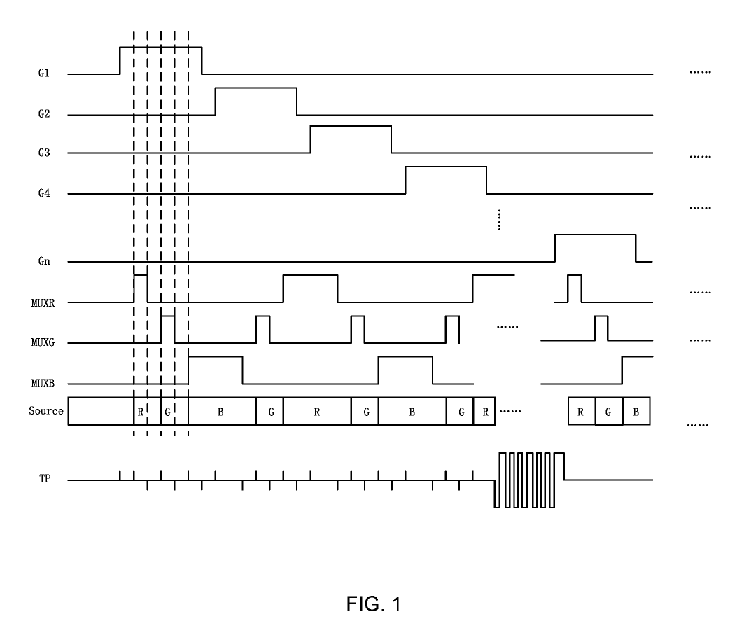

Please refer to FIG. 1. FIG. 1 is a sequence diagram of respective signals in the touch control device drive method according to one preferred embodiment of the present invention. The touch control device can be a touch control device, such as a touch control screen mobile phone, touch control navigation system but not limited thereto. The touch control device is an in-cell touch control device. The touch control device drive method is specifically introduced as below.

S1, providing a plurality of touch control drive signals, wherein the plurality of touch control drive signals are employed for detecting a position where a touch point of the touch control device is. In FIG. 1, TP represents the touch control drive signal. In FIG. 1, the position where TP is a straight line means that the touch control drive signal at this moment is a direct current signal, and then the touch control device does not receive any touch control operation. The line protruding above or under the direct current is a glitch. The part of which TP is an alternating current means that the touch control device receives the touch control operation at this moment, and the plurality of touch control drive signals cooperate with one another and are employed for detecting a position where a touch point of the touch control device is.

S2, providing a plurality of scan signals, wherein each scan signal is loaded on a gate of a thin film transistor on an array substrate in the touch control device, and the scan signal is a periodic signal, and in one period, the scan signal comprises a first high voltage level signal, of which a duration is a first preset time, and the first high voltage level signals of the two adjacent scan signals are spaced with a first time interval, wherein the first time interval is larger than the first preset time. In FIG. 1, G1, G2, G3, . . . Gn represent a plurality of scan signals.

S3, providing a plurality of switch signals, wherein each switch signal comprises a first switch sub signal, a second switch sub signal and a third switch sub signal, and the first switch sub signal, the second switch sub signal and the third switch sub signal are respectively employed to control on or off of a first thin film transistor corresponded with a first color sub pixel, a second thin film transistor corresponded with a second color sub pixel and a third thin film transistor corresponded with a third color sub pixel in one pixel, and the first switch sub signal, the second switch sub signal and the third switch sub signal cooperate with one another to be activate the first thin film transistor, the second thin film transistor and the third thin film transistor, and in one period, the first switch sub signal, the second switch sub signal, the third switch sub signal, the third switch sub signal, the second switch sub signal and the first switch sub signal sequentially control the corresponding thin film transistors to be activated, and different two switch sub signals which are adjacent are spaced with a second time interval, and no interval is between the same switch sub signals which are adjacent, and in the same point of the same period, no more than one switch sub signal controls the corresponding thin film transistor to be activated. In FIG. 1, MUXR, MUXG and MUXB respectively represent the first switch sub signal, the second switch sub signal and the third switch sub signal in one switch signal. In other words, for the same switch signal, MUXR represents the first switch sub signal in the switch signal, and MUXG represents the second switch sub signal in the switch signal, and MUXB represents the third switch sub signal in the switch signal.

Specifically, that the first switch sub signal, the second switch sub signal and the third switch sub signal are respectively employed to control on or off of a first thin film transistor corresponded with a first color sub pixel, a second thin film transistor corresponded with a second color sub pixel and a third thin film transistor corresponded with a third color sub pixel in one pixel means that for the same pixel, the first switch sub signal is employed to control on or off of the first thin film transistor corresponded with the first color sub pixel in the pixel, and the second switch sub signal is employed to control on or off of the second thin film transistor corresponded with the second color sub pixel in the pixel, and the third switch sub signal is employed to control on or off of the third thin film transistor corresponded with the third color sub pixel in the pixel.

It can be understood that the sequence of the aforesaid steps S1, S2 and S3 is not restricted to the aforesaid description. The touch control drive signal, the scan signal and the switch signal can be loaded on the touch control device at the same time to drive the touch control device.

In two adjacent periods, no interval is between the same switch sub signals which are adjacent. Specifically, in this embodiment, in the end of each period, it ends with the first switch sub signal, and in the beginning of each period, it begins with the first switch sub signal. Therefore, the switch sub signal in the end of the nth period and the sub signal in the beginning of the n+1th period are the same (both are the first switch sub signals), and no interval is between the first switch sub signal in the end of the nth period and the sub signal in the beginning of the n+1th period. n is a natural number. It can be understood that the activation duration that the first switch sub signal in the end of the nth period controls the corresponding thin film transistor is T1, and the activation duration that the first switch sub signal in the beginning of the n+1th period controls the corresponding thin film transistor is T2. Namely, in the two adjacent periods, in the end of the nth period and in the beginning of the n+1th period, the lasting activation duration that the first switch sub signal controls the corresponding thin film transistor is T1+T2. It can be understood that T1 can be equal to T2, or T1 is not equal to T2.

In comparison with prior art, in one period, the first switch sub signal, the second switch sub signal, the third switch sub signal, the third switch sub signal, the second switch sub signal and the first switch sub signal sequentially control the corresponding thin film transistors to be activated, and no interval is between the same switch sub signals which are adjacent. Namely, the same switch sub signals which are adjacent are not required to switch, and thus the number of sequential high low voltage level switches can be decreased. Thus, the one interference to the touch control drive signal can be decreased so that the in the period, the number of the glitches in the touch control signals is decreased by one, and then the effect of the touch control drive is promoted.

Furthermore, in two adjacent periods, no interval is between the same switch sub signals which are adjacent. Thus, in the two adjacent periods, no interval is between the adjacent switch sub signals. Thus, the switch number of the high low voltage levels as switching from one period to the next period can be decreased. Therefore, the one interference to the touch control drive signal can be decreased so that the in the period, the number of the glitches in the touch control signals is decreased by one, again, and then the effect of the touch control drive is promoted in advance.

The touch control device drive method further comprises S4.

S4, providing a plurality of charging signals, wherein each charging signal comprises a first charging sub signal, a second charging sub signal and a third charging sub signal, and the first charging sub signal, the second charging sub signal and the third charging sub signal are respectively employed to charge a first sub pixel electrode coupled to the first thin film transistor in the first color sub pixel, a second sub pixel electrode coupled to the second thin film transistor in the second color sub pixel and a third sub pixel electrode coupled to the third thin film transistor in the third color sub pixel in one pixel, and the first charging sub signal, the second charging sub signal and the third charging sub signal cooperate with one another to periodically charge the first sub pixel electrode, the second sub pixel electrode and the third sub pixel electrode, and in one period, as first switch sub signal is applied on the first thin film transistor, the first charging sub signal charges the first sub pixel, and as the second switch sub signal is applied on the second thin film transistor, the second charging sub signal charges the second sub pixel, and as the third switch sub signal is applied on the third thin film transistor, the third charging sub signal charges the third sub pixel. In this embodiment, the first color sub pixel is a red sub pixel, and the second color sub pixel is a green sub pixel, and the third color sub pixel is a blue sub pixel. For convenience of understanding, in FIG. 1, Source is used to represent that the charging signal charges the sub pixel of which color. In FIG. 1, what is indicated with R represents that the charging signal charges the red sub pixel at this moment, and what is indicated with G represents that the charging signal charges the green sub pixel at this moment, and what is indicated with B represents that the charging signal charges the green sub pixel at this moment.

It can be understood that the sequence of the aforesaid steps S1, S2, S3 and S4 is not restricted to the aforesaid description. The touch control drive signal, the scan signal, the switch signal and the charging signal can be loaded on the touch control device at the same time to drive the touch control device.

In one period, the scan signal further comprises a first low voltage level signal, of which a duration is a second preset time, and the first high voltage level signal is 7V, and the first low voltage level signal is −5V. In comparison with prior art that the high voltage level signal of the scan signal is 9V, and the low voltage level signal is −7V. Under the premise that the thin film transistor which is driven normally works, the scan signal of the present invention makes the voltage difference of the scan signal decrease from 16V in prior art to 12V. Therefore, the peak value of the glitch generated due to the influence to the touch control drive signal as switching the scan signal high low voltage levels is decreased to promote the effect of the touch control drive.

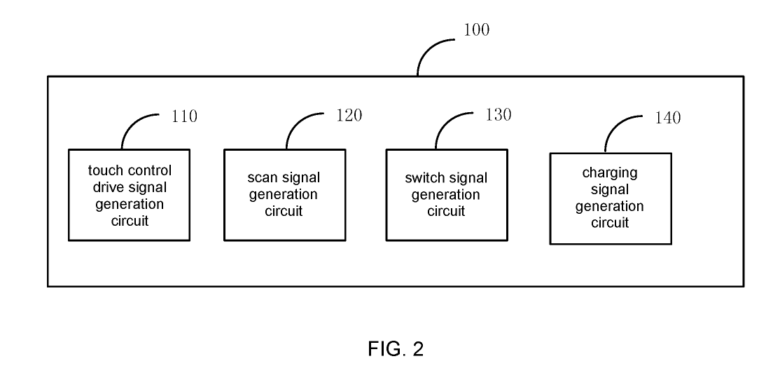

The present invention further provides a touch control device drive circuit. Please refer to FIG. 2. FIG. 2 is a circuit block diagram of the touch control device drive circuit according to one preferred embodiment of the present invention. The touch control device drive circuit 100 comprises a touch control drive signal generation circuit 110, a scan signal generation circuit 120 and a switch signal generation circuit 130.

The touch control drive signal generation circuit 110 is employed for generating a plurality of touch control drive signals, wherein the plurality of touch control drive signals are employed for detecting a position where a touch point of the touch control device is.

The scan signal generation circuit 120 is employed for generating a plurality of scan signals, wherein each scan signal is loaded on a gate of a thin film transistor on an array substrate in the touch control device, and the scan signal is a periodic signal, and in one period, the scan signal comprises a first high voltage level signal, of which a duration is a first preset time, and the first high voltage level signals of the two adjacent scan signals are spaced with a first time interval, wherein the first time interval is larger than the first preset time.

The switch signal generation circuit 130 is employed for generating a plurality of switch signals, wherein each switch signal comprises a first switch sub signal, a second switch sub signal and a third switch sub signal, and the first switch sub signal, the second switch sub signal and the third switch sub signal are respectively employed to control on or off of a first thin film transistor corresponded with a first color sub pixel, a second thin film transistor corresponded with a second color sub pixel and a third thin film transistor corresponded with a third color sub pixel in one pixel, and the first switch sub signal, the second switch sub signal and the third switch sub signal cooperate with one another to be activate the first thin film transistor, the second thin film transistor and the third thin film transistor, and in one period, the first switch sub signal, the second switch sub signal, the third switch sub signal, the third switch sub signal, the second switch sub signal and the first switch sub signal sequentially control the corresponding thin film transistors to be activated, and different two switch sub signals which are adjacent are spaced with a second time interval, and no interval is between the same switch sub signals which are adjacent, and in the same point of the same period, no more than one switch sub signal controls the corresponding thin film transistor to be activated.

In two adjacent periods, no interval is between the same switch sub signals which are adjacent. Specifically, in this embodiment, in the end of each period, it ends with the first switch sub signal, and in the beginning of each period, it begins with the first switch sub signal. Therefore, the switch sub signal in the end of the nth period and the sub signal in the beginning of the n+1th period are the same (both are the first switch sub signals), and no interval is between the first switch sub signal in the end of the nth period and the sub signal in the beginning of the n+1th period. n is a natural number. It can be understood that the activation duration that the first switch sub signal in the end of the nth period controls the corresponding thin film transistor is T1, and the activation duration that the first switch sub signal in the beginning of the n+1th period controls the corresponding thin film transistor is T2. Namely, in the two adjacent periods, in the end of the nth period and in the beginning of the n+1th period, the lasting activation duration that the first switch sub signal controls the corresponding thin film transistor is T1+T2. It can be understood that T1 can be equal to T2, or T1 is not equal to T2.

The touch control device drive device 100 further comprises a charging signal generation circuit 140. The charging signal generation circuit 140 is employed for generating a plurality of charging signals, wherein each charging signal comprises a first charging sub signal, a second charging sub signal and a third charging sub signal, and the first charging sub signal, the second charging sub signal and the third charging sub signal are respectively employed to charge a first sub pixel electrode coupled to the first thin film transistor in the first color sub pixel, a second sub pixel electrode coupled to the second thin film transistor in the second color sub pixel and a third sub pixel electrode coupled to the third thin film transistor in the third color sub pixel in one pixel, and the first charging sub signal, the second charging sub signal and the third charging sub signal cooperate with one another to periodically charge the first sub pixel electrode, the second sub pixel electrode and the third sub pixel electrode, and in one period, as first switch sub signal is applied on the first thin film transistor, the first charging sub signal charges the first sub pixel, and as the second switch sub signal is applied on the second thin film transistor, the second charging sub signal charges the second sub pixel, and as the third switch sub signal is applied on the third thin film transistor, the third charging sub signal charges the third sub pixel.

In one period, the scan signal further comprises a first low voltage level signal, of which a duration is a second preset time, and the first high voltage level signal is 7V, and the first low voltage level signal is −5V.

The first color sub pixel is a red sub pixel, and the second color sub pixel is a green sub pixel, and the third color sub pixel is a blue sub pixel. It is understandable that in other embodiments, the first color sub pixel, the second color sub pixel and the third color sub pixel are other combinations of the red sub pixel, the green sub pixel and the blue sub pixel.

It can be understood that the touch control drive signal generation circuit 110, the scan signal generation circuit 120, the switch signal generation circuit 130 and the charging signal generation circuit 140 can be four independent circuits, and also can be four independent integrated chips, and also can be integrated as one chip.

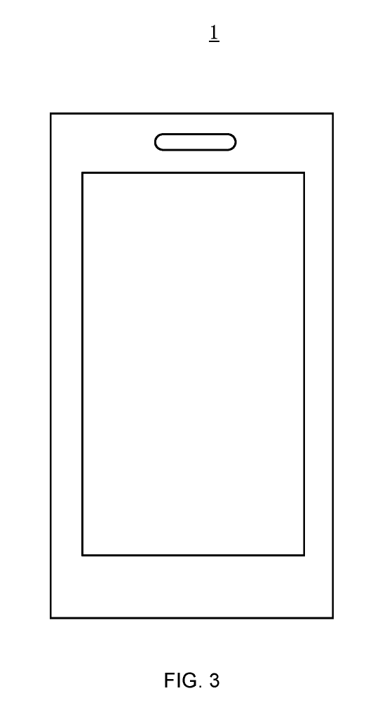

The present invention further provides a touch control device 1. Please refer to FIG. 3. FIG. 3 is a structure diagram of the touch control device according to one preferred embodiment of the present invention. The touch control device 1 can be a touch control device, such as a touch control screen mobile phone, touch control navigation system but not limited thereto. The touch control device 1 comprises the touch control drive circuit 10 in any one embodiment as aforementioned. The repeated description is omitted here.

Above are embodiments of the present invention, which does not limit the scope of the present invention. Any modifications, equivalent replacements or improvements within the spirit and principles of the embodiment described above should be covered by the protected scope of the invention.

What is claimed is:

1. A touch control device drive method, applied in a touch control device, wherein the touch control device drive method comprises:
providing a plurality of touch control drive signals, wherein the plurality of touch control drive signals are employed for detecting a position where a touch point of the touch control device is;
providing a plurality of scan signals, wherein each scan signal is loaded on a gate of a thin film transistor on an array substrate in the touch control device, and the scan signal is a periodic signal, and in one period, the scan signal comprises a first high voltage level signal, of which a duration is a first preset time, and the first high voltage level signals of the two adjacent scan signals are spaced with a first time interval, wherein the first time interval is larger than the first preset time; and
providing a plurality of switch signals, wherein each switch signal comprises a first switch sub signal, a second switch sub signal and a third switch sub signal, and the first switch sub signal, the second switch sub signal and the third switch sub signal are respectively employed to control on or off of a first thin film transistor corresponded with a first color sub pixel, a second thin film transistor corresponded with a second color sub pixel and a third thin film transistor corresponded with a third color sub pixel in one pixel, and the first switch sub signal, the second switch sub signal and the third switch sub signal cooperate with one another to be activate the first thin film transistor, the second thin film transistor and the third thin film transistor, and in one period, the first switch sub signal, the second switch sub signal, the third switch sub signal, the third switch sub signal, the second switch sub signal and the first switch sub signal sequentially control the corresponding thin film transistors to be activated, and different two switch sub signals which are adjacent are spaced with a second time interval, and no interval is between the same switch sub signals which are adjacent, and in the same point of the same period, no more than one switch sub signal controls the corresponding thin film transistor to be activated.

2. The touch control device drive method according to claim 1, wherein in two adjacent periods, no interval is between the same switch sub signals which are adjacent.

3. The touch control device drive method according to claim 1, wherein the touch control device drive method further comprises:
providing a plurality of charging signals, wherein each charging signal comprises a first charging sub signal, a second charging sub signal and a third charging sub signal, and the first charging sub signal, the second charging sub signal and the third charging sub signal are respectively employed to charge a first sub pixel electrode coupled to the first thin film transistor in the first color sub pixel, a second sub pixel electrode coupled to the second thin film transistor in the second color sub pixel and a third sub pixel electrode coupled to the third thin film transistor in the third color sub pixel in one pixel, and the first charging sub signal, the second charging sub signal and the third charging sub signal cooperate with one another to periodically charge the first sub pixel electrode, the second sub pixel electrode and the third sub pixel electrode, and in one period, as first switch sub signal is applied on the first thin film transistor, the first charging sub signal charges the first sub pixel, and as the second switch sub signal is applied on the second thin film transistor, the second charging sub signal charges the second sub pixel, and as the third switch sub signal is applied on the third thin film transistor, the third charging sub signal charges the third sub pixel.

4. The touch control device drive method according to claim 1, wherein in one period, the scan signal further comprises a first low voltage level signal, of which a duration is a second preset time, and the first high voltage level signal is 7V, and the first low voltage level signal is −5V.

5. A touch control drive circuit, applied in a touch control device, wherein the touch control drive circuit comprises:
a touch control drive signal generation circuit, employed for generating a plurality of touch control drive signals, wherein the plurality of touch control drive signals are employed for detecting a position where a touch point of the touch control device is;
a scan signal generation circuit, employed for generating a plurality of scan signals, wherein each scan signal is loaded on a gate of a thin film transistor on an array substrate in the touch control device, and the scan signal is a periodic signal, and in one period, the scan signal comprises a first high voltage level signal, of which a duration is a first preset time, and the first high voltage level signals of the two adjacent scan signals are spaced with a first time interval, wherein the first time interval is larger than the first preset time; and
a switch signal generation circuit, employed for generating a plurality of switch signals, wherein each switch signal comprises a first switch sub signal, a second switch sub signal and a third switch sub signal, and the first switch sub signal, the second switch sub signal and the third switch sub signal are respectively employed to control on or off of a first thin film transistor corresponded with a first color sub pixel, a second thin film transistor corresponded with a second color sub pixel and a third thin film transistor corresponded with a third color sub pixel in one pixel, and the first switch sub signal, the second switch sub signal and the third switch sub signal cooperate with one another to be activate the first thin film transistor, the second thin film transistor and the third thin film transistor, and in one period, the first switch sub signal, the second switch sub signal, the third switch sub signal, the third switch sub signal, the second switch sub signal and the first switch sub signal sequentially control the corresponding thin film transistors to be activated, and different two switch sub signals which are adjacent are spaced with a second time interval, and no interval is between the same switch sub signals which are adjacent, and in the same point of the same period, no more than one switch sub signal controls the corresponding thin film transistor to be activated.

6. The touch control device drive circuit according to claim 5, wherein in two adjacent periods, no interval is between the same switch sub signals which are adjacent.

7. The touch control drive circuit according to claim 5, wherein the touch control drive circuit further comprises:
a charging signal generation circuit, employed for generating a plurality of charging signals, wherein each charging signal comprises a first charging sub signal, a second charging sub signal and a third charging sub signal, and the first charging sub signal, the second charging sub signal and the third charging sub signal are respectively employed to charge a first sub pixel electrode coupled to the first thin film transistor in the first color sub pixel, a second sub pixel electrode coupled to the second thin film transistor in the second color sub pixel and a third sub pixel electrode coupled to the third thin film transistor in the third color sub pixel in one pixel, and the first charging sub signal, the second charging sub signal and the third charging sub signal cooperate with one another to periodically charge the first sub pixel electrode, the second sub pixel electrode and the third sub pixel electrode, and in one period, as first switch sub signal is applied on the first thin film transistor, the first charging sub signal charges the first sub pixel, and as the second switch sub signal is applied on the second thin film transistor, the second charging sub signal charges the second sub pixel, and as the third switch sub signal is applied on the third thin film transistor, the third charging sub signal charges the third sub pixel.

8. The touch control device drive device according to claim 5, wherein in one period, the scan signal further comprises a first low voltage level signal, of which a duration is a second preset time, and the first high voltage level signal is 7V, and the first low voltage level signal is −5V.

9. The touch control device drive device according to claim 5, wherein the first color sub pixel is a red sub pixel, and the second color sub pixel is a green sub pixel, and the third color sub pixel is a blue sub pixel.

10. A touch control device, wherein the touch control device comprises the touch control drive circuit according to claim 5.
